(19) United States
(12) Patent Application Publication
(10) Pub. No.: US 2014/0309818 A1
(43) Pub. Date: Oct. 16, 2014

(54) RAM AIR TURBINE AUTODEPLOYMENT LOGIC

(71) Applicant: HAMILTON SUNDSTRAND CORPORATION, Windsor Locks, CT (US)

(72) Inventors: Robert L. Seagren, Rockford, IL (US); Jef William Good, German Valley, IL (US); Joshua Berg, Rockford, IL (US)

(73) Assignee: Hamilton Sundstrand Corporation, Windsor Locks, CT (US)

(21) Appl. No.: 13/862,799

(22) Filed: Apr. 15, 2013

(51) Int. Cl. B64C 19/00

(52) U.S. Cl. CPC B64C 19/00
USPC 701/3

(57) ABSTRACT

A ram air turbine deployment module includes a normal power module that determines if normal power from an aircraft is available, an air-ground module that determines if the aircraft is off the ground, a ground-maintenance module that determines if the aircraft is presently having maintenance preformed, and decision logic that provides an output to a ram air turbine that deploys the ram air turbine if normal power from the aircraft is not available, the aircraft is off the ground, and the aircraft is not presently having maintenance performed.

### BACKGROUND

Aircraft include ram air turbines (RATs) for emergency power. If power is lost from main and auxiliary power generators, a RAT may be deployed to provide power to critical systems. These RATs provide air generated power based upon the speed of the aircraft. They often remain retracted within the aircraft when not in use, and deploy out of the aircraft when needed. In the past, RATs have been deployed manually by a pilot of the aircraft. RATs have recently begun being deployed automatically. It is desirable to prevent the RAT from deploying when the aircraft is not in flight. Therefore, transient conditions, errors, and other factors created due to the use of computer systems must be handled.

### SUMMARY

A ram air turbine deployment module includes a normal power module, an air-ground module, a ground-maintenance module, and decision logic. The normal power module determines if normal power from an aircraft is available. The air-ground module determines if the aircraft is off the ground. The ground-maintenance module that determines if the aircraft is presently having maintenance preformed. The decision logic provides an output to a ram air turbine and deploys the ram air turbine if normal power from the aircraft is not available, the aircraft is off the ground, and the aircraft is not presently having maintenance performed.

### BRIEF DESCRIPTION OF THE DRAWINGS

FIG. 1 is a block diagram illustrating an electronic auto-deployment system for a ram air turbine.

FIG. 2 is a circuit diagram illustrating a digital logic auto-deployment module for a ram air turbine.

FIG. 3 is a flowchart illustrating a method of auto-deploying a ram air turbine using electronic controls.

### DETAILED DESCRIPTION

The present invention relates to ram air turbines (RATs), and in particular to a system and method for automatically deploying RATs. A digital logic circuit monitors, among other things, primary power contactors, auxiliary power contactors, external generator power contactors, weight-on-wheels (WOW) inputs, and a speed threshold input. The output of the digital logic circuit controls deployment of the RAT by engaging a RAT deployment solenoid. The output of the digital logic circuit deploys the RAT if power is not available from the primary and auxiliary generators, the aircraft is not on the ground, and the aircraft is not receiving power from an external generator. Determining if the plane is not on the ground includes monitoring two WOW inputs and a speed threshold input. Auto-deployment of the RAT is also delayed for a predetermined amount of time after the digital logic circuit is powered on.

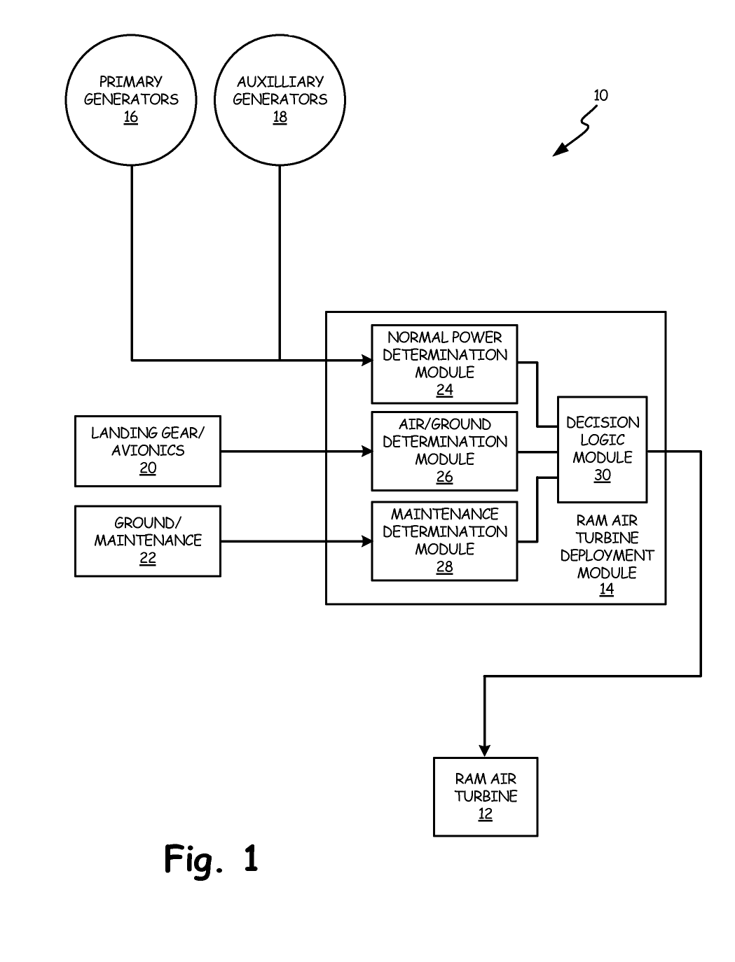

FIG. 1 is a block diagram illustrating an electronic auto-deployment system 10 for RAT 12. System 10 includes auto-deployment module 14, primary generators 16, auxiliary generators 18, landing gear/avionics inputs 20, and ground/maintenance inputs 22. Auto-deployment module 14 includes normal power determination module 24, air/ground determination module 26, ground/maintenance determination module 28, and decision logic module 30. Primary generators are any primary sources of power for an aircraft such as, for example, the main engine generators. Auxiliary generators 18 are any generators that provide auxiliary power for the aircraft such as, for example, an auxiliary power unit (APU). Landing gear/avionics inputs 20 are aircraft computer systems that provide sensor data to auto-deployment module 14. These systems may include WOW computer systems, speed sensors, or any other computer/sensor information desired by auto-deployment module 14. Ground/maintenance inputs 22 are inputs such as, for example, a contactor input indicating that the aircraft is receiving power from an external generator.

Auto-deployment module 14 provides an output to engage a deployment solenoid of RAT 12 based upon inputs to auto-deployment module 14. Module 14 may be implemented as any type of digital logic circuit such as, for example, a field programmable gate array (FPGA), a microprocessor-based unit, or an application specific integrated circuit (ASIC). Module 14 may be implemented as a standalone circuit, or may be incorporated in a control system, such as, for example, an emergency control system of an aircraft. Normal power determination module 24 determines if power is available from either primary generators 16 or auxiliary generators 18. Air/ground determination module 26 determines if the aircraft is in the air based upon, for example, inputs from WOW computer systems and speed sensors. Ground/maintenance determination module 28 determines if the aircraft is on the ground based upon, for example, receiving power from an external power generator. This is important because, for example, if the aircraft is on jacks, the WOW systems will not indicate that the aircraft is off the ground, which could lead to unwanted deployment.

Auto-deployment module 14 deploys RAT 12 if normal power is not available, the aircraft is off the ground, and the aircraft is not receiving power from an external generator. Decision logic module 30 outputs a control signal based upon outputs from normal power determination module 24, air/ground determination module 26, and ground/maintenance determination module 28. This output engages the deployment solenoid of RAT 12 if normal power determination module 24 indicates no power is available from primary generators 16 or auxiliary generators 18, air/ground determination module 26 determines the aircraft is not on the ground, and ground maintenance determination module 28 determines that the aircraft is not receiving power from an external generator.

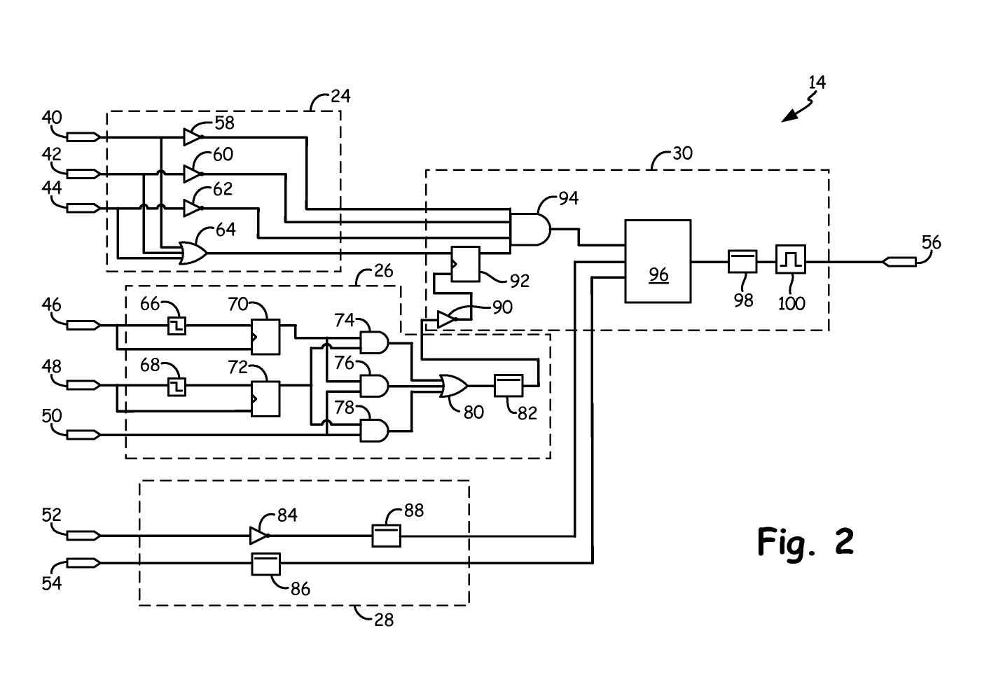

FIG. 2 is a circuit diagram illustrating a digital logic auto-deployment module 14 for a ram air turbine. Auto-deployment module 14 includes normal power determination module 24, air/ground determination module 26, ground/maintenance determination module 28, decision logic module 30, power contactor inputs 40, 42 and 44, weight-on-wheels (WOW) inputs 46 and 48, speed threshold input 50, external generator power input 52, cold start input 54, and RAT deployment output 56. In the present embodiment, normal power determination module 24 includes inverters 58, 60 and 62, and OR gate 64. Air/ground determination 26 includes edge detectors 66 and 68, latches 70 and 72, AND gates 74, 76, and 78, OR gate 80, and time delay module 82. Ground/maintenance determination module 28 includes inverter 84, and time delay modules 86 and 88. Decision logic module 30 includes inverter 90, latch 92, AND gates 94 and 96, time delay module 98, and one-shot module 100.

Normal power determination module 24 provides digital signals indicative of power availability from primary and auxiliary generators. The signals on inputs 40, 42 and 44 may, for example, be contactor signals from two primary generators and an auxiliary generator. The signals may be logic high if power is available from the respective generator. Inverters 58, 60 and 62 are used to invert the signals from inputs 40, 42 and 44 so that the outputs of inverters 58, 60 and 62 are logic high when power is unavailable from the respective power sources. The output of OR gate 64 is a signal that is logic high if any of the normal power sources are available. While illustrated with three normal power source inputs, any number of inputs may be included if, for example, the aircraft includes more than three primary and auxiliary generators. Monitoring contactor signals is advantageous to monitoring, for example, bus voltages because bus voltages are susceptible to transient conditions.

Air/ground determination module 26 determines if the aircraft is in the air based upon inputs 46, 48 and 50. WOW inputs 46 and 48 are received from, for example, avionics weight-on-wheels computer systems onboard the aircraft. Both WOW inputs 46 and 48 may be logic high to indicate that the respective WOW computer system has determined that the aircraft is on the ground, and may be logic low to indicate that the respective WOW computer system has determined that the aircraft is in the air. Edge detectors 66 and 68, along with latches 70 and 72 are used to ensure that a transition from ground to air occurs, rather than just monitoring for the in-air signal. This is desirable because during power up, the WOW signals can take some time to transition to the ground state, which may lead to unwanted RAT deployment if not accounted for. For example, upon detection of a falling edge transition on WOW inputs 46 and 48, respective edge detectors 66 and 68 provide a logic high for a given time period. Latches 70 and 72 are any digital logic latches and may be implemented as, for example, set-reset latches. When edge detectors 66 and 68 provide a logic high, respective latches 70 and 72 are set to a logic high output. Air speed threshold input 50 is also used to determine if the aircraft is in the air. Input 50 is, for example, logic high if the air speed is greater than a threshold value such as, for example, fifty knots. This input may come from any aircraft system capable of measuring aircraft speed.

Air/ground determination module 26 indicates that the aircraft is in the air if two of the three inputs 46, 48 and 50 indicate that the aircraft is in the air. The outputs of latches 70 and 72, and the air speed threshold input 50 are provided to AND gates 74, 76 and 78. The output of each AND gate 74, 76 and 78 indicates that two of the three cases are indicating that the aircraft is in the air. These outputs are provided to OR gate 80 to provide a single output indicative of the aircraft being off the ground. Time delay module 82 provides a predetermined time delay such as, for example, one second. When the output of OR gate 80 transitions high, time delay module 82 delays one second, ensuring that the output remains high for at least one second, and then provides the logic high output indicative of the aircraft being off the ground. This ensures that no transients in any of the aircraft systems create a false indication that the aircraft is in the air.

Ground/maintenance module 28 determines, for example, if the aircraft is receiving power from an external generator, or if auto-deployment module 14 has just begun receiving power. Input 52 is received from, for example, an external power generator contactor. Inverter 84 is used to provide a logic high if power is not being received from an external generator. This is desirable because, for example, when the plane is on jacks for maintenance and is receiving external power, air/ground determination module 26 may indicate that the aircraft is off the ground because WOW computer systems will determine that the aircraft is off the ground, which may lead to unwanted deployment of the RAT if not accounted for. Time delay module 88 is implemented to accommodate for power down of the external power source while the plane is on jacks. Input 54 is representative of a cold start signal for auto-deployment module 14. This signal transitions to a logic high when auto-deployment module 14 is powered on. This may come from module 14 itself, or from external to module 14. Time delay module 86 provides a time delay of, for example, ten seconds to allow for the rest of the system to reach a stable operating state.

Decision logic module 30 provides an output to deploy the RAT based upon the outputs from normal power determination module 24, air/ground determination module 26, and ground/maintenance module 28. The output of OR gate 64 and inverter 90 are provided to latch 92 which may be, for example, a set-reset latch. If the output of OR gate 64 is high, indicating that power is available from at least one of either the primary or auxiliary generators, the output of latch 92 is set to a logic high state. This ensures that power was available from one of the primary or auxiliary generators prior to deployment of the RAT. The output of inverter 90 is a logic low if the aircraft is in the air. When the aircraft transitions to the ground, the output of inverter 90 is a logic high which transitions the output of latch 92 to a logic low state. Therefore, the output of latch 92, if logic high, indicates that the aircraft is in the air, and has previously seen power from one of the primary or auxiliary generators. AND gates 94 and 96 determine if this case is true, if there is no longer power from the primary or auxiliary generators, if there is no power from an external generator, and auto-deployment module 14 has been powered on for greater than a predetermined time. If all these conditions are true, the output of AND gate 96 is logic high, indicating that the RAT should be deployed. Time delay module 98 outputs a logic high if the input is a logic high for greater than a predetermined amount of time such as, for example, two hundred milliseconds. This guards against any brief glitches, transients, or errors in the digital logic of auto-deployment module 14 or any of its inputs. One-shot module 100 is a digital logic module that provides a single pulse when the output of time delay module 98 is high. The RAT only deploys one time during a flight, and thus, only one pulse is provided to the solenoid to deploy the RAT.

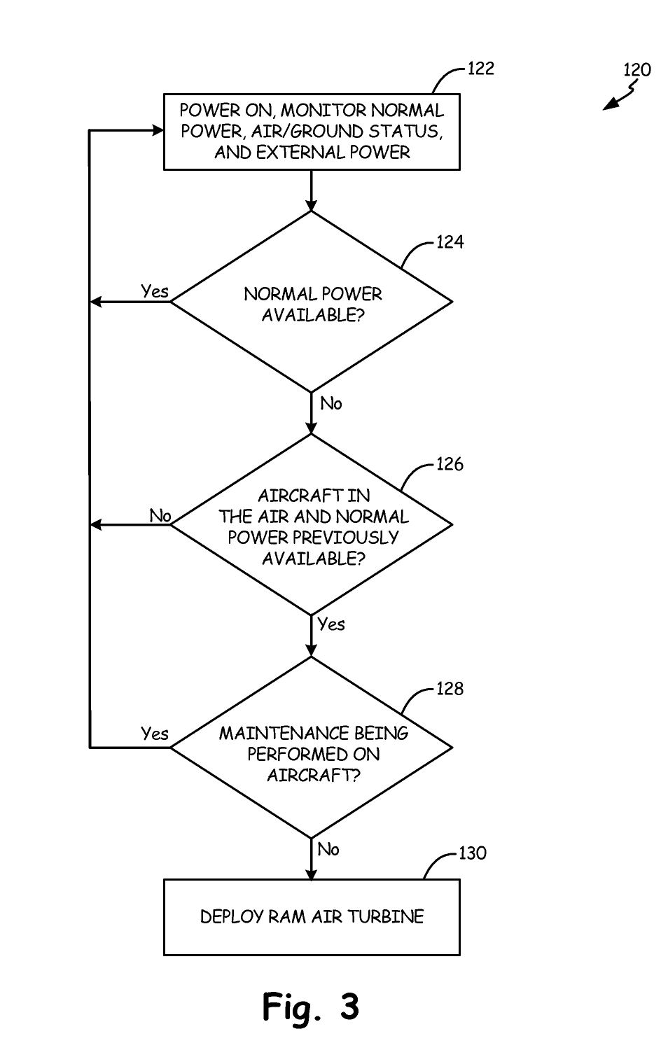

FIG. 3 is a flowchart illustrating method 120 of auto-deploying ram air turbine 12 using auto-deployment module 14. At step 122, auto-deployment module is powered on, delays ten seconds, and then monitors for normal power, air/ground status, and external power. At step 124, it is determined if normal power is available from either primary or auxiliary generators. If yes, method 120 remains at step 124. If no, method 120 proceeds to step 126. At step 126, it is determined if the aircraft is off the ground, and if auto-deployment module 14 has previously seen power from one of either the primary generators or an auxiliary generator. If no, method 120 returns to step 124. If yes, method 120 proceeds to step 128. At step 128, it is determined if power from an external generator is being provided to the aircraft. If it is, method 120 returns to step 124. If no, method 120 proceeds to step 130 and deploys the RAT.

The following are non-exclusive descriptions of possible embodiments of the present invention.

A ram air turbine deployment module includes, among other things: a normal power module that determines if normal power from an aircraft is available, an air-ground module that determines if the aircraft is off the ground, a ground-maintenance module that determines if the aircraft is presently having maintenance preformed, and decision logic that provides an output to a ram air turbine that deploys the ram air turbine if normal power from the aircraft is not available, the aircraft is off the ground, and the aircraft is not presently having maintenance performed.

The ram air turbine deployment module of the preceding paragraph can optionally include, additionally and/or alternatively, any one or more of the following features, configurations and/or additional components:

The normal power module determines if normal power from the aircraft is available based upon contactor inputs from one or more primary power generators.

The normal power module determines if normal power from the aircraft is available based further upon contactor inputs from one or more auxiliary power generators.

The air-ground module determines if the aircraft is off the ground based upon two weight-on-wheels inputs and a speed threshold input.

The air-ground module determines that the aircraft is in the air based upon at least two the following three being true: the first weight-on-wheels input indicates the aircraft is in the air; the second weight-on-wheels input indicates the aircraft is in the air; and the speed threshold input indicates the aircraft is travelling at greater than a threshold speed.

The ground-maintenance module determines if maintenance is being performed by determining if the aircraft is receiving power from an external generator.

The output of the decision logic provides a one-shot pulse to deploy the ram air turbine.

A time-delay module that prevents the output from deploying the ram air turbine for a predetermined time period after the ram air turbine deployment module has been powered on.

A method of deploying a ram air turbine of an aircraft includes, among other things: determining if normal power from the aircraft is unavailable using a deployment module, determining if the aircraft is off the ground using the deployment module, determining if the aircraft is not presently having maintenance performed using the deployment module, and deploying the ram air turbine if the normal power from the aircraft is unavailable, if the aircraft is off the ground, and if the aircraft is not presently having maintenance performed.

The method of the preceding paragraph can optionally include, additionally and/or alternatively, any one or more of the following features, configurations and/or additional components:

Determining if normal power from the aircraft is unavailable includes determining if power is available from one or more primary generators or one or more auxiliary generators.

Determining if the aircraft is off of the ground comprises determining if at least two of the following three are true: a first weight-on-wheels input indicates that the aircraft is off the ground; a second weight-on-wheels input indicates that the aircraft is off the ground; and an aircraft speed threshold input indicates the aircraft is travelling at greater than a threshold speed.

Determining if the aircraft is not presently having maintenance performed includes determining if the aircraft is receiving power from an external generator.

Deploying the ram air turbine includes providing a one-shot pulse to the ram air turbine.

Delaying deploying the ram air turbine for a predetermined time period following power-on of the deployment module.

A system includes, among other things: a ram air turbine and a deployment module. The deployment module determines if power is being received from a primary generator, auxiliary generator, or external generator, and the deployment module determines if the aircraft is in the air based upon a first weight-on-wheels input, a second weight on wheels input, and a speed threshold input. The deployment module provides an output to deploy the ram air turbine if the deployment module determines that power is not being received from the primary generator, the auxiliary generator, or the external generator, and the deployment module determines that the aircraft is in the air.

The system of the preceding paragraph can optionally include, additionally and/or alternatively, any one or more of the following features, configurations and/or additional components:

The deployment module determines that the aircraft is in the air by determining that at least two of the following three are true: the first weight-on-wheels input indicates the aircraft is in the air; the second weight-on-wheels input indicates the aircraft is in the air; and the speed threshold input indicates that a speed of the aircraft is greater than a threshold value.

The output to deploy the ram air turbine is a one-shot pulse provided to the ram air turbine.

The deployment module does not provide the output to deploy the ram air turbine for a predetermined time period after the deployment module has been powered on.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A ram air turbine deployment module comprising:
a normal power circuit configured to determine if normal power from an aircraft is available;
an air-ground circuit configured to determine if the aircraft is off the ground;
a ground-maintenance circuit configured to determine if the aircraft is presently having maintenance preformed; and
decision logic circuitry that provides an output to a ram air turbine that deploys the ram air turbine if normal power from the aircraft is not available, the aircraft is off the ground, and the aircraft is not presently having maintenance performed.

2. The ram air turbine deployment module of claim 1, wherein the normal power circuit determines if normal power from the aircraft is available based upon contactor inputs from one or more primary power generators.

3. The ram air turbine deployment module of claim 2, wherein the normal power circuit determines if normal power from the aircraft is available based further upon contactor inputs from one or more auxiliary power generators.

4. The ram air turbine deployment module of claim 1, wherein the air-ground circuit determines if the aircraft is off the ground based upon two weight-on-wheels inputs and a speed threshold input.

5. The ram air turbine deployment module of claim 4, wherein the air-ground ground circuit determines that the aircraft is in the air based upon at least two the following three being true:
a. the first weight-on-wheels input indicates the aircraft is in the air;
b. the second weight-on-wheels input indicates the aircraft is in the air; and
c. the speed threshold input indicates the aircraft is travelling at greater than a threshold speed.

6. The ram air turbine deployment module of claim 1, wherein the ground-maintenance circuit determines if maintenance is being performed by determining if the aircraft is receiving power from an external generator.

7. The ram air turbine deployment module of claim 1, wherein the output of the decision logic circuitry provides a one-shot pulse to deploy the ram air turbine.

8. The ram air turbine deployment module of claim 1, further comprising a time-delay circuit that prevents the output from deploying the ram air turbine for a predetermined time period after the ram air turbine deployment module has been powered on.

9. A method of deploying a ram air turbine of an aircraft, the method comprising:
determining, using deployment circuitry, if normal power from the aircraft is unavailable;
determining, using the deployment circuitry, if the aircraft is off the ground;
determining, using the deployment circuitry, if the aircraft is not presently having maintenance performed; and
deploying, using the deployment circuitry, the ram air turbine if the normal power from the aircraft is unavailable, if the aircraft is off the ground, and if the aircraft is not presently having maintenance performed.

10. The method of claim 9, wherein determining if normal power from the aircraft is unavailable comprises determining if power is available from one or more primary generators or one or more auxiliary generators.

11. The method of claim 9, wherein determining if the aircraft is off of the ground comprises determining if at least two of the following three are true:
a. a first weight-on-wheels input indicates that the aircraft is off the ground;
b. a second weight-on-wheels input indicates that the aircraft is off the ground; and
c. an aircraft speed threshold input indicates the aircraft is travelling at greater than a threshold speed.

12. The method of claim 9, wherein determining if the aircraft is not presently having maintenance performed comprises determining if the aircraft is receiving power from an external generator.

13. The method of claim 9, wherein deploying the ram air turbine comprises providing a one-shot pulse to the ram air turbine.

14. The method of claim 9, further comprising delaying deploying the ram air turbine for a predetermined time period following application of power to the deployment circuitry.

15. A system comprising:
a ram air turbine; and
a deployment circuit;
wherein the deployment circuit determines if power is being received from a primary generator, auxiliary generator, or external generator, and wherein the deployment circuit determines if the aircraft is in the air based upon a first weight-on-wheels input, a second weight on wheels input, and a speed threshold input; and
wherein the deployment circuit provides an output to deploy the ram air turbine if the deployment circuit determines that power is not being received from the primary generator, the auxiliary generator, or the external generator, and the deployment circuit determines that the aircraft is in the air.

16. The system of claim 15, wherein the deployment circuit determines that the aircraft is in the air by determining that at least two of the following three are true:
a. the first weight-on-wheels input indicates the aircraft is in the air;
b. the second weight-on-wheels input indicates the aircraft is in the air; and
c. the speed threshold input indicates that a speed of the aircraft is greater than a threshold value.

17. The system of claim 15, wherein the output to deploy the ram air turbine is a one-shot pulse provided to the ram air turbine.

18. The system of claim 15, wherein the deployment circuit does not provide the output to deploy the ram air turbine for a predetermined time period after application of power to the deployment circuit.
